(19) United States
(12) Patent Application Publication
(10) Pub. No.: US 2022/0129342 A1
(43) Pub. Date: Apr. 28, 2022

(54) CONSERVING COMPUTER RESOURCES THROUGH QUERY TERMINATION

(71) Applicant: Zendesk, Inc., San Francisco, CA (US)

(72) Inventors: Jean-François Pascal Topige, Copenhagen (DK); Benjamin Quorning, Copenhagen (DK); Leon Lucas Teixeira Maia, Copenhagen (DK); Kalyan S. Wunnava, Livermore, CA (US)

(73) Assignee: Zendesk, Inc., San Francisco, CA (US)

(21) Appl. No.: 17/505,168

(22) Filed: Oct. 19, 2021

Related U.S. Application Data
(60) Provisional application No. 63/104,896, filed on Oct. 23, 2020.

(51) Int. Cl. G06F 11/07; G06F 16/21; G06F 11/34

(52) U.S. Cl. CPC G06F 11/0772; G06F 11/3476; G06F 11/3419; G06F 16/21

(57) ABSTRACT

A query terminator executes within a computing environment featuring multiple applications and/or services that access a shared database, and operates to interrupt, halt, or terminate processes (e.g., queries) that misbehave in order to conserve computing resources. Illustrative misbehavior includes execution for an excessive period of time. Queries submitted by the applications/services are tagged to identify their origin, responsible teams, endpoints, resources, and/or other metadata. Queries that are susceptible to forced termination are also tagged with timeout values. The query terminator for a given application or service identifies queries from the application that are currently executing on the database, examines their metadata, and interrupts or terminates those that have been executing longer than their timeout values. Metadata regarding terminated processes is logged and provided to the responsible teams.

### RELATED APPLICATION(S)

This application claims the benefit of U.S. Provisional Application No. 63/104,896, which was filed Oct. 23, 2020 and is incorporated herein by reference.

### BACKGROUND

This disclosure relates to the field of computer systems. More particularly, a system and methods are provided for conserving computer resources by proactively halting computing processes that are or that may be wasting the resources.

In typical computing environments, a user or a computer process may misbehave by using excessive computer resources (e.g., disk space, processor time, communication bandwidth). For example, in a shared database environment in which multiple users, programs, processes, and/or other entities share a database or a portion of a database (e.g., a shard, a replica), the longer a given database query executes, the longer the resources used for the query are monopolized by one entity. A long-running query not only prevents other entities from using the monopolized resources, but the impact on the database may affect other queries that are executing at the same time (e.g., by causing them to run slower).

At the same time, however, some queries may necessarily execute for relatively long periods of time and/or may have high priorities. Thus, while a misbehaving query or process could be manually terminated, it may be counter-productive to simply terminate all such processes that appear to be misbehaving.

### SUMMARY

In some embodiments, systems and methods are provided for conserving computer resources by intelligently interrupting or terminating misbehaving computer processes within a computing environment, and collecting and recording relevant information to promote resolution or correction of the offending behavior. By appropriately tagging or marking computer processes with the relevant information the system can avoid terminating processes that should not be terminated despite apparent misbehavior.

In these embodiments, multiple applications and/or services submit queries to a shared database on behalf of users and/or other processes. Some or all queries are tagged, marked, or otherwise decorated with certain metadata. The metadata may provide such information as the name or other identifier of the application or service that initiated the query, a maximum expected, estimated or normal time of execution of the query (e.g., an average or median determined over time), an application resource that initiated the query and/or a resource invoked by the query, an endpoint for the query, an identifier of a development team responsible for the query, etc.

For each application (and service), an application-specific query terminator runs in parallel with the application to identify database nodes accessed (or that may be accessed) by the application's queries, obtain details (e.g., running time, associated metadata) from each node regarding queries from the application that are executing on the node, and examines those details to identify queries that should be terminated. For example, queries that have been running longer than their expected run time may be targeted for termination.

Queries that normally run for long periods of time, queries that are high priority, and/or other queries (e.g., queries that have been thoroughly examined and found to have no errors, queries associated with particular applications or users) may be tagged or marked in a way that prevents a normal query terminator from interrupting or terminating the query.

Moreover, a global query terminator may execute across multiple or all applications (and services) and target for termination all queries that execute longer than a relatively lengthy time period (e.g., 15 minutes). Again, however, some queries may be excluded from being targeted by the global query terminator.

### DESCRIPTION OF THE FIGURES

FIG. 1 is a block diagram depicting a computing environment in which a query terminator may be implemented, in accordance with some embodiments.

FIG. 2 is a block diagram illustrating a shared database environment in which a query terminator operates, in accordance with some embodiments.

FIG. 3 is a flow chart illustrating a method of using a query terminator, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, systems and methods are provided for preventing queries and/or other processes from monopolizing computer resources. For example, database queries that execute for periods of time in excess of one or more predetermined limits may be identified and selectively terminated depending on properties or metadata associated with the queries.

In these embodiments, some or all queries are preconfigured and are tagged or marked to provide information such as the application or service that submitted the query, an associated development or programming team, an indicator as to whether the query can or cannot be terminated for apparent misbehavior, an application resource that spawned the query, a resource accessed by the query, an endpoint of the query, a normal execution time for the query, etc.

A query terminator executes continually to search for queries and/or other processes that execute too long, consume too many resources (e.g., storage space, processor time), or otherwise misbehave. Identified processes are examined and terminated if permitted. Some or all metadata associated with the terminated queries is logged and provided to developers or other entities for use in debugging or modifying the queries.

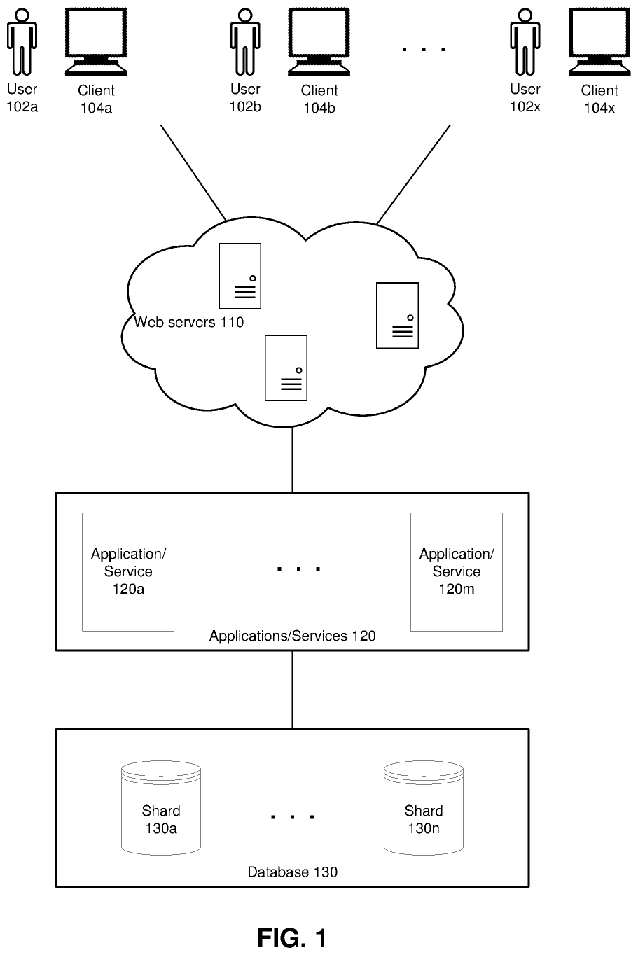

FIG. 1 depicts a computing environment in which database queries and/or other processes may be automatically and forcibly terminated due to apparent misbehavior, according to some embodiments.

In computing environment 100 of FIG. 1, users 102 (users 102a-102x) within an organization (or across multiple organizations) operate user clients 104 (clients 104a-104x) to execute one or more web-based applications and/or services 120 (applications/services 120a-120m) via web servers 110. Thus, each user client 104 may execute a browser that interacts with web servers 110 to provide a corresponding user 102 with an interface specific to a particular application or service. In some other embodiments, users and clients access applications and/or services directly, without web servers 110 (e.g., in a client/server setting).

Applications 120 store data in database 130, which includes multiple shards 130a-130n. During the course of their use of an application, a user may initiate any number of requests to the application, which will attempt to retrieve pertinent data from database 130 and provide a suitable response. In particular, an application or service may offer its users preconfigured queries to execute upon database 130 and/or the ability to construct a custom query.

Depending on the application or applications hosted by the organization(s), database 130 may store sales records; customer profiles; customer service information; customer communications, feedback, and/or complaints; technical information; details of products/services; and so on, in which case applications 120 and web server 110 provide users with web-based interfaces for performing sales tasks, providing or obtaining customer service, providing or obtaining technical support, etc. User data requests submitted via web server 110 may not be optimized or the requested data may not be indexed, and so a given user request may persist for a relatively long period of time.

In some embodiments, web server 110 automatically terminates a user request that does not complete within a specified period of time (e.g., 15 seconds, 1 minute), but the web server may not be able to terminate a back-end database search or query (e.g., a database query executing on database 130) that was initiated in response to the user request. Furthermore, a user may repeatedly enter a particular request that is terminated by the web server due to the time threshold, which means that more and more database queries may be spawned, orphaned, and continue consuming resources (e.g., processor bandwidth, storage space). In these embodiments, a query terminator identifies and terminates or otherwise interrupts orphaned database queries and/or other queries or processes that appear to misbehave.

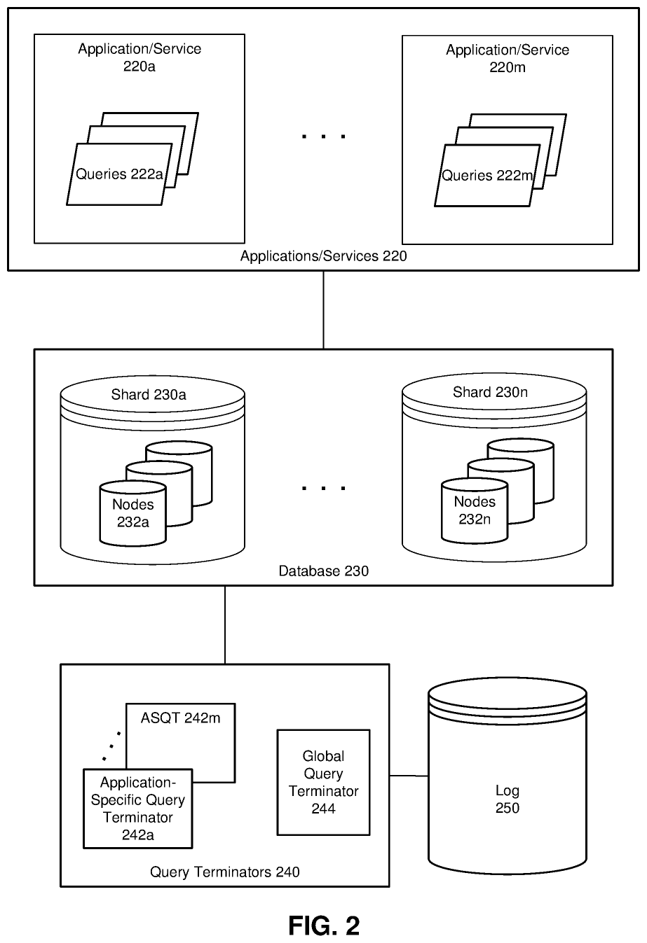

FIG. 2 is a block diagram illustrating a shared database environment in which a query terminator operates, according to some embodiments.

In these embodiments, and as described above, each application or service 220 (e.g., applications/services 220a-220m) that is hosted by an organization that supports or provides the database environment offers various queries 222 (e.g., queries 222a-222m) to its users. These queries are executed against database 230, which includes multiple shards 230 (e.g., shards 230a-230n). Each shard includes multiple nodes 232 (e.g., nodes 232a of shard 230a, nodes 232n of shard 230n). A given node may be a reader node, a writer node, or a combined reader/writer node. Any number of queries from any number of applications or services may concurrently execute upon a given shard and upon a given node of a given shard.

One or more query terminators 240 identify active database nodes, identify queries 222 executing upon the active nodes, obtain and examine metadata or properties of the queries, determine whether any of them merit termination (or interruption) and, if so, automatically terminate them if such action is permitted. Some or all the metadata of a terminated query may be recorded in log 250, and may be used to issue alerts or reports to system personnel responsible for the terminated queries 222 and/or the associated application/service 220. A query terminator may be a physical or virtual computer, a process or other logical construct (e.g., a thread) executing on a physical or virtual computer, or a collection of physical and/or logical entities that cooperate to terminate misbehaving database queries and/or other computer processes. A query terminator may be referred to as a module, a process, a service, a device, etc.

Application-specific query terminators 242 include separate query terminator modules for some or all applications/services 220. Thus, application-specific query terminator (ASQT) 242a may correspond to application/service 220a, ASQT 242b may correspond to application/service 220b, etc. Further, each application/service-specific query terminator 242 executes under the same user identifier as the queries submitted by the corresponding application/server 220.

Therefore, in an environment in which all queries submitted by a given application or service are submitted to database 230 under the same user identifier, the corresponding application-specific query terminator will execute with the same identity. A given application-specific query terminator 242 therefore only has sufficient privileges to find and proactively terminate queries submitted by its corresponding application or service 220.

Preconfigured queries for applications and services that have an associated application-specific query terminator 242 are configured to include some number of “required” tags in order to access the database. If custom queries can be generated by a user via an application, those queries will be embellished to include at least the required tags. Some applications and/or services, however, may not be configured for use with an application-specific query terminator, in which case they may submit database queries that do not include any tags or that do not include all required tags. Because a purpose of deploying a query terminator is to provide feedback to a responsible development team regarding possible issues with certain queries, in some implementations queries that are not tagged with certain information may not be terminated by an application-specific query terminator.

However, in some embodiments, global query terminator 244 operates across all applications, services, and/or other processes that initiate database queries. In these embodiments, global query terminator 244 is designed to identify and terminate (or interrupt) queries that run for abnormally long periods of time (e.g., 15 minutes, 30 minutes) that may be configured automatically or manually by an administrator. The global query terminator may have an associated whitelist and/or blacklist that identify, respectively, queries that it may and may not terminate. A query that necessarily requires a significant period of time to execute may be placed on the blacklist, for example, while applications and/or services that do not have corresponding application-specific query terminators 242 may be included in the whitelist.

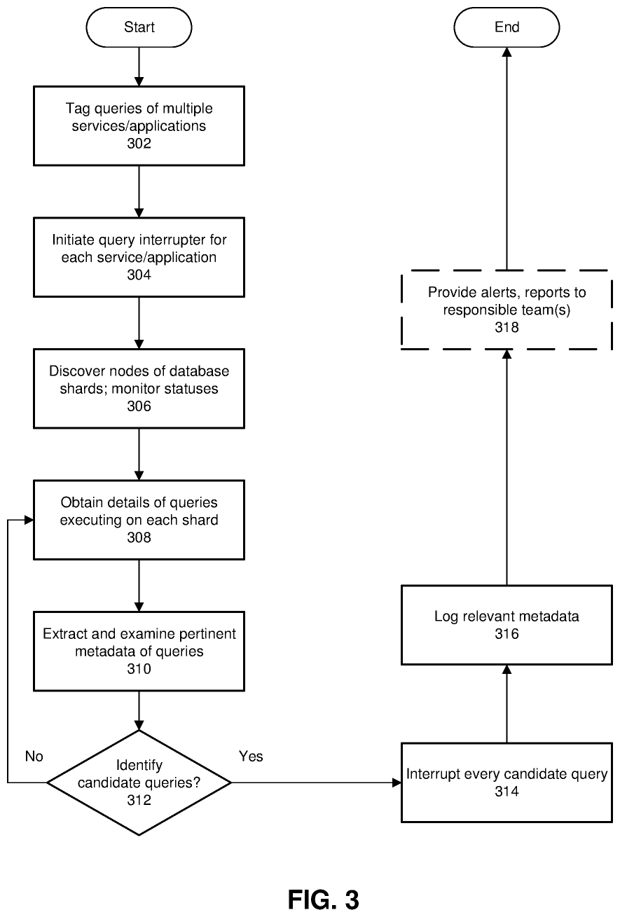

FIG. 3 is a flow chart illustrating a method of using a query terminator, according to some embodiments.

In operation 302, multiple queries associated with multiple applications and/or services are tagged, marked, or modified to include comments that include information about the sources of the queries, endpoints, resource(s), etc. In some embodiments, required tags for each query include service, resource, and trace_id. The service tag identifies the application or service that initiated or triggered the query; the resource tag identifies the application resource responsible for the query; the trace_id tag identifies a trace of a service request. For example, a given trace_id may describe the layers of an application that were invoked to service the request (e.g., a web server, a database call, a call to another service, generation of HTML).

Some optional tags (which may be required in other embodiments) include timeout, code_owner, an interruptible flag, and user_id. The time out tag reports the maximum time the query is expected to run; the code_owner tag identifies (e.g., in GitHub®) a developer or a development team responsible for the query; the interruptible flag is a Boolean value that indicates whether the system can terminate the query before it ends naturally; the user_id tag identifies a user account with which the query was executed. In some implementations, an application-specific query terminator device or process cannot terminate a running query unless the interruptible flag is set to True and the query has been executing or running for a period of time greater than timeout. If a query is encountered that omits the interruptible flag, its value may be assumed to be either True or False.

A query may be marked with other information in other embodiments, such as an identifier of the database shard or partition on which the query usually runs, a version number of the application or service associated with the query, a query fingerprint (e.g., a hash of the query at a particular stage), etc.

In operation 304, for each participating application or service a query terminator specific to that application is initiated. It may, for example, be spawned at the same time as the application, with the same user identity and privileges that will be used to execute database queries for the application. As described above, a global query terminator may also be instantiated (e.g., when a first application is initiated). Whereas an application-specific query terminator may only be able to see and affect queries from the associated application, the global query terminator may be able to see and access all queries across all applications.

In operation 306, an application's query terminator searches for and discovers nodes of database shards to which queries initiated by the application will be directed. The application-specific query terminator will monitor the statuses of the discovered nodes (e.g., up or down) and will learn of new nodes coming online, on an ongoing basis, until the query terminator is halted. It may be noted that operations 306 through 316 will execute repeatedly and in parallel for every query terminator.

In operation 308, an application-specific query terminator polls or queries all active nodes discovered in operation 308 to identify queries of the application that are currently executing. Each node may be interrogated separately or a request to identify queries may be broadcast to multiple nodes simultaneously.

During this operation, the query terminator obtains some or all metadata regarding the identified queries, and also obtains their current running time (e.g., the amount of time the query has been executing) from active nodes. In some embodiments, the query terminator only searches for queries that have been running for a minimum period of time, such as 1 second, 100 milliseconds, etc., which may be configured by an administrator. This reduces the amount of processing the query terminator must perform to identify target queries.

In operation 310, for each query currently executing (or that has been executing for at least a minimum period of time), the corresponding application's query terminator examines relevant metadata to determine whether the query should and can be terminated. For example, the query terminator may examine the interruptible flag and ignore all queries whose flag value is False. For other queries, the query terminator may simply compare the query's timeout value with its current running time.

In operation 312, candidate queries that can and should be terminated are identified, if any. In some embodiments, this includes every currently executing query that has an interruptible flag value of True and whose current running time exceeds its timeout value. In some implementations, the current running time must exceed the timeout value by some percentage or by some specific measure of time.

If no such queries are identified, the illustrated method returns to operation 306 (to check active database nodes) or operation 308 (to again obtain query details). When at least one query is identified for termination, the method advances to operation 314.

In operation 314, every query identified in operation 312 is terminated.

In operation 316, metadata for every terminated query is logged. The logged data may include some or all metadata and/or properties with which the queries were marked or tagged. In particular, the logged metadata may at least include information that identifies the corresponding application or service, and the developer or development team responsible for the query. Associated information may also be logged, such as amount of time for which the query executed prior to being terminated, a timestamp identifying when the query was terminated, which database node was executing the query, etc.

In optional operation 318, alerts, reports or other notifications may be automatically dispatched to parties responsible for the terminated queries. Information may be aggregated and a notification may be dispatched only after multiple terminations for the same query have occurred. Responsible parties may be informed of how often or how many times a particular query has been terminated during some specified time period.

Based on these notifications, a terminated query may be examined more closely to determine if it is constructed properly and to reconfigure or reword it if necessary. As one alternative, it may be determined that the query seems to misbehave when executed against one or more specific sets of data, but runs without issue against other datasets.

In embodiments in which a global query terminator is implemented, operations 306 through 318 may proceed in the same or a similar manner for the global query terminator as for the application-specific query terminators. One difference, of course, is that the global query terminator will not be limited to examination of only one application or service's queries. Instead, it runs with sufficient privileges to access and terminate most or all queries executing on the database. Further, instead of comparing a given query's current execution time to an expected period of time identified in the query's tags, the global query terminator compares the query's current execution time to a predefined time period that applies to all queries.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method of conserving computer resources, the method comprising:
for each of multiple applications and/or services, configuring one or more associated queries to execute upon a shared database;
tagging each query with tags that comprise an origin of the query and an estimated run time for the query; and
for each application and service, operating a corresponding query terminator to:
identify queries currently running on the database that are associated with the corresponding application or service;
for each identified query, determine whether the identified query is using excessive computing resources; and
terminate each identified query that is determined to be using excessive computing resources, except for identified queries with tags that prevent termination of the query.

2. The method of claim 1, further comprising:
logging at least a subset of the tags for each terminated query, including a tag that identifies the origin of the terminated query.

3. The method of claim 1, further comprising operating a global query terminator to:
identify candidate queries running on the database that are associated with any application or service and that have been running longer than a predetermined period of time; and
terminate candidate queries that are not excluded from termination;
wherein the global query terminator has an associated exclusion list to exclude specified queries from termination.

4. The method of claim 1, wherein identifying queries currently running on the database that are associated with the corresponding application or service comprises:
polling each of multiple database nodes to determine statuses of the nodes; and
receiving, from each active node, information identifying each currently executing query that is associated with the corresponding application or service;
wherein the information received for a currently executing query includes some or all of the tags for the query.

5. The method of claim 1, wherein determining whether the identified query is using excessive computing resources comprises:
for each identified query currently executing on the database, receiving the query's tags and a current duration of execution of the query; and
comparing the estimated run time with the current duration of execution.

6. The method of claim 1, wherein the origin of the query identifies one or more of:
the service or application associated with the query;
a code owner of the query;
a trace to a source of the query;
a user identifier associated with the query; and
a resource of the service or application that initiated the query.

7. The method of claim 1, wherein the tags further include:
a fingerprint of the query; and
a flag indicating whether or not the query terminator corresponding to the associated application or service is permitted to terminate the query.

8. The method of claim 1, further comprising:
after a given query is terminated, notifying one or more entities responsible for the query regarding the termination;
wherein the notification includes some or all of the tags of the terminated query.

9. The method of claim 1, wherein:
users access the multiple applications and services via web servers that submit user requests to the multiple applications and services;
the multiple applications and services query the shared database in response to at least some of the user requests;
the web servers terminate user requests that are not resolved within a predetermined period of time; and
the web servers cannot terminate queries on the shard database that were caused by the terminated user requests.

10. A non-transitory computer-readable medium storing instructions that, when executed by a processor, cause the processor to perform a method of conserving computer resources, the method comprising:
for each of multiple applications and/or services, configuring one or more associated queries to execute upon a shared database;
tagging each query with tags that comprise an origin of the query and an estimated run time for the query; and
for each application and service, operating a corresponding query terminator to:
identify queries currently running on the database that are associated with the corresponding application or service;
for each identified query, determine whether the identified query is using excessive computing resources; and
terminate each identified query that is determined to be using excessive computing resources, except for identified queries with tags that prevent termination of the query.

11. The non-transitory computer-readable medium of claim 10, wherein the method further comprises:
logging at least a subset of the tags for each terminated query, including a tag that identifies the origin of the terminated query.

12. The non-transitory computer-readable medium of claim 10, wherein the method further comprises operating a global query terminator to:
identify candidate queries running on the database that are associated with any application or service and that have been running longer than a predetermined period of time; and
terminate candidate queries that are not excluded from termination;
wherein the global query terminator has an associated exclusion list to exclude specified queries from termination.

13. The non-transitory computer-readable medium of claim 10, wherein identifying queries currently running on the database that are associated with the corresponding application or service comprises:
polling each of multiple database nodes to determine statuses of the nodes; and
receiving, from each active node, information identifying each currently executing query that is associated with the corresponding application or service;
wherein the information received for a currently executing query includes some or all of the tags for the query.

14. The non-transitory computer-readable medium of claim 10, wherein determining whether the identified query is using excessive computing resources comprises:
for each identified query currently executing on the database, receiving the query's tags and a current duration of execution of the query; and
comparing the estimated run time with the current duration of execution.

15. The non-transitory computer-readable medium of claim 10, wherein the origin of the query identifies one or more of:
the service or application associated with the query;
a code owner of the query;
a trace to a source of the query;
a user identifier associated with the query; and
a resource of the service or application that initiated the query.

16. A system for conserving computing resources, comprising:
one or more processors;
memory storing instructions that, when executed by the one or more processors cause the system to:
for each of multiple applications and/or services, configure one or more associated queries to execute upon a shared database;
tag each query with tags that comprise an origin of the query and an estimated run time for the query; and
for each application and service, operate a corresponding query terminator to:
identify queries currently running on the database that are associated with the corresponding application or service;
for each identified query, determine whether the identified query is using excessive computing resources; and
terminate each identified query that is determined to be using excessive computing resources, except for identified queries with tags that prevent termination of the query.

17. The system of claim 16, further comprising:
multiple application servers hosting the multiple applications and services; and
multiple web servers providing users with web-based access to the multiple applications and services.

18. The system of claim 16, further comprising:
one or more query terminator servers that host the query terminators corresponding to the multiple applications and services.

19. The system of claim 16, further comprising:
one query terminator server hosting a global query terminator process configured to:
identify candidate queries running on the database that are associated with any application or service and that have been running longer than a predetermined period of time; and
terminate candidate queries that are not excluded from termination;
wherein the global query terminator has an associated exclusion list to exclude specified queries from termination.

20. The system of claim 16, further comprising:
a log for logging at least a subset of the tags for each terminated query, including a tag that identifies the origin of the terminated query;
wherein after a given query is terminated, one or more entities responsible for the query are notified of regarding the termination; and
wherein the notification includes some or all of the tags of the terminated query.

21. A method of conserving computer resources, the method comprising:
for each of multiple applications and/or services, configuring and storing one or more associated queries to execute upon a shared database when invoked by users;
tagging each query with tags that comprise an origin of the query and an estimated run time for the query; and
for each application and service, operating a corresponding query terminator to:
identify queries currently running on the database that are associated with the corresponding application or service;
for each identified query, determine that the identified query is using excessive computing resources when a current duration of execution of the query exceeds the query's estimated run time; and
terminate each identified query that is determined to be using excessive computing resources, except for identified queries with tags that prevent termination of the query.
